(19) United States
(12) Patent Application Publication
(10) Pub. No.: US 2015/0169794 A1
(43) Pub. Date: Jun. 18, 2015

(54) UPDATING LOCATION RELEVANT USER BEHAVIOR STATISTICS FROM CLASSIFICATION ERRORS

(71) Applicant: Google Inc., Mountain View, CA (US)

(72) Inventor: Hartmut Maennel, Zurich (CH)

(73) Assignee: Google Inc., Mountain View, CA (US)

(21) Appl. No.: 13/829,406

(22) Filed: Mar. 14, 2013

(51) Int. Cl. G06F 17/50

(52) U.S. Cl. CPC G06F 17/5009

(57) ABSTRACT

Methods, systems, and apparatus, including computer programs encoded on computer storage media, for determining geographic locations of devices. One of the methods includes obtaining an estimated user location associated with each respective IP address block based on observed events; obtaining an estimate of a probability model using the estimated user locations; using the estimate for the probability model and the observed events to calculate an estimate for multiple probability distributions; generating a modified estimate of the probability model; calculating a updated estimate for each of the multiple probability distributions using the adjusted estimate of the probability model; and determining a further adjustment to the estimate of the probability model based on a comparison between an overall number of outliers present in the estimates for the multiple probability distributions and an overall number of outliers present in the updated estimates for the multiple probability distributions.

### BACKGROUND

This specification relates to determining geographic locations of devices on a network.

Knowing the geographical location of a device coupled to a network, e.g., the Internet, can be valuable to provide new or improved services to the device or to users of the device. For instance, news, weather alerts, advertisements, and other services can be selected based on knowing where a user device is located.

### SUMMARY

In general, one innovative aspect of the subject matter described in this specification can be embodied in methods that include the actions of obtaining an estimated user location associated with each respective IP address block of multiple IP address blocks based on observed events from the IP address block; obtaining an estimate of a probability model p(ev|loc) using the obtained estimated user locations, the probability model p(ev|loc) including a respective probability distribution of interest locations for each of multiple user locations, each value p(evᵢ|locⱼ) of the probability model p(ev|loc) representing a respective probability that event queries issued from a user location locⱼ have an interest location evᵢ; using the estimate for the probability model p(ev|loc) and the observed events to calculate an estimate for multiple probability distributions X(loc), each probability distribution X(loc) being associated with a respective IP address block; generating a modified estimate of the probability model p(ev|loc) by changing at least some probability values in the probability model p(ev|loc); calculating a updated estimate for each of the multiple probability distributions X(loc) using the adjusted estimate of the probability model p(ev|loc); determining a further adjustment to the estimate of the probability model p(ev|loc) based on a comparison between an overall number of outliers present in the estimates for the multiple probability distributions X(loc) and an overall number of outliers present in the updated estimates for the multiple probability distributions X(loc); and using the estimate of the probability model p(ev|loc) modified with the further adjustment to calculate a further estimate for each of the multiple probability distributions X(loc). Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method further includes for a first probability distribution X₁(loc) in the multiple probability distributions X(loc)s: determining respective number of outliers present in the estimate for the first probability distribution X₁(loc); and determining respective number of outliers present in the updated estimate for the first probability distribution X₁(loc). Determining the respective number of outliers present in the estimate for the first probability distribution X₁(loc) includes: determining a respective radius rₘ for each user location locₘ in the first probability distribution X₁(loc) such that a fraction of the probability mass of the probability distribution X₁(loc) is included in an area centered around the user location locₘ and having the radius rₘ; calculating a median of the respective radii for all the user locations represented in the first probability distribution X₁(loc); identifying one or more user locations from the first probability distribution X₁(loc) as outliers for the first probability distribution X₁(loc), where the respective radii for the identified one or more user locations are at least a first multiplier greater than the median; and excluding the identified one or more user locations from the first probability distribution X₁(loc) as outliers. Determining the respective number of outliers present in the estimate of first probability distribution X₁(loc) further includes: repeating the determining, calculating, identifying, and excluding of claim 3 for a predetermined number of times or until a predetermined threshold amount of the original probability mass is excluded from the first probability distribution X₁(loc). The fraction is 10%, the first multiplier is four, the predetermined number of times is 3 times, and the predetermined threshold amount of the original probability mass is 10%. Using the estimate for the probability model p(ev|loc) and the observed events to calculate an estimate for multiple probability distributions X(loc) including: calculating the estimate for the probability distribution X(loc) using an iterative Expectation Maximization (EM) process until a current estimate of the probability distribution X(loc) converges according to a second predetermined threshold, the EM process including: computing a probability model q(loc|ev) based on the current estimate of the probability distribution X(loc) according to a first equation

$$q ( loc / ev ) = \frac{p ( ev / loc ) \cdot X ( loc )}{{\sum }_{{loc}^{′}} p ( ev / {loc}^{′} ) \cdot X ( {loc}^{′} )} ;$$

and updating the current estimate of the probability distribution X(loc) according to a second equation

$$x ( loc ) = \frac{1}{N} {\sum }_{i = 1}^{N} q ( loc / {ev}_{i} ) ,$$

where ev₁, ev₂, . . . ev_{N}, represents observed interest locations. Adjusting the estimate of the probability model p(ev|loc) further includes increasing a first value p(ev₁|loc₁) of the probability model p(ev|loc) by a first amount; and determining the further adjustment to the estimate of the probability model p(ev|loc) based on the comparison includes: upon determination that the overall number of outliers present in the updated estimates for the multiple probability distributions X(loc) is greater than the overall number of outliers present in the estimates for the multiple probability distributions X(loc), reducing the first amount added to the first value p(ev₁|loc₁) or decreasing the first value p(ev₁|loc₁) of the probability model p(ev|loc) by a second amount.

Particular embodiments of the subject matter described in this specification can be implemented so as to realize one or more of the following advantages. The techniques described in this specification can improve the accuracy of a geographical position estimate of a device on a network, in particular, of devices on the Internet. Specifically, using a model of event generation allows the system to infer locations from observed events. Outliers identified in the resulting location estimates can be used to improve the model, which can lead to better estimates that are more likely to be correct. In particular, removing user locations determined to be outliers can improve the accuracy of a geographical position estimate of a device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is flowchart of an example method of obtaining an adjusted probability distribution for an internet protocol (IP) address block.

FIG. 2 is a flowchart of an example method of adjusting a probability distribution based on outliers.

FIG. 3 is a flowchart of an example method for determining outliers in a probability distribution.

Like reference numbers and designations in the various drawings indicate like elements.

### DETAILED DESCRIPTION

A probability distribution X(loc) can be estimated for each of multiple IP address blocks. Each IP address in the IP address block is a numerical label associated with a particular user device, e.g., a computer. Each user device is also associated with one or more geographic locations. IP addresses are assigned to networks in different sized IP address blocks.

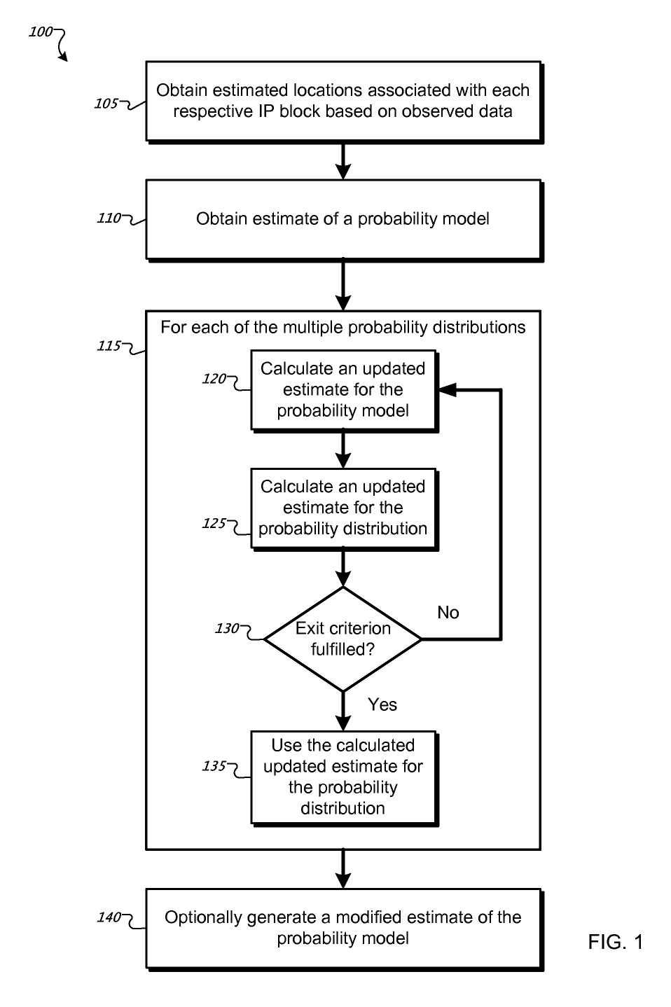

The probability distribution X(loc) for a particular IP address block indicates how likely it is that event queries (Q) received from IP addresses in that IP address block were issued from various user locations (loc). The event queries (Q) refer to queries obtained from a query log and that are directed to some location of interest (ev). For example, queries in the form “restaurant in New York” or queries seeking map directions with a particular starting location, e.g., query seeking the location of Z on a map. A probability model p(ev|loc) is used to generate estimated probability distribution for each of multiple IP address blocks. Generating estimated probability distributions for each of multiple IP address blocks is described below with respect to FIG. 1.

Errors in the probability model p(ev|loc) results in an error in the probability distribution X(loc). This error can be identified by the outliers in the probability distribution X(loc). Thus, identifying outliers in X(loc) provides a way to detect errors in the probability model.

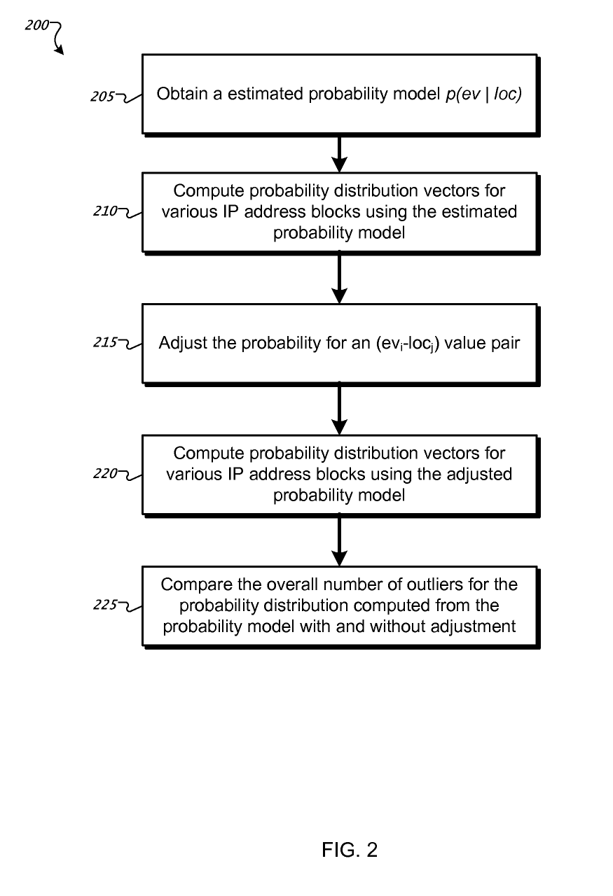

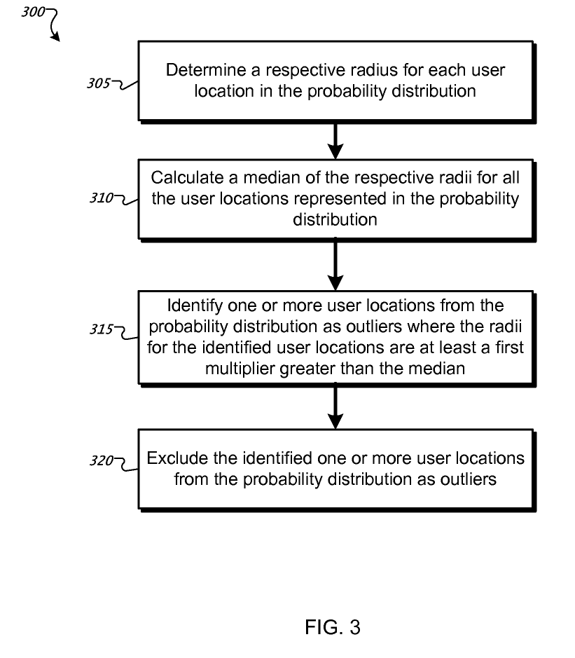

For example, if the probability distribution for an IP address block shows a probability mass of 0.95 for user locations in Italy (loc=Italy) and a probability mass of 0.05 for user locations in Singapore (loc=Singapore), then it is likely that the probability mass given to Singapore represents an outlier that should be removed. Detection of outliers and adjustment of a corresponding probability distribution are described below with respect to FIGS. 2 and 3.

FIG. 1 is flowchart of an example method 100 of obtaining an adjusted probability distribution for an internet protocol (IP) address block. For convenience, the method 100 will be described with respect to a system having one or more computers that performs the method 100.

The system obtains (105) location estimates for each IP address block of a set of IP address blocks b based on observed data.

In particular, given a particular IP address block, the likelihood of a particular observed event from that particular block b, N(ev|b), can be determined from observed query data in a particular time span. Therefore, the location of the IP address block b can be estimated from the observed N(ev|b) if it is assumed that all users are in approximately the same location (loc) and the event locations are clustered around this loc.

Several techniques can be used to determine the location of each IP address block. In some implementations, the location is assigned to each IP address block by taking the “center” of the observed location of interest. In some alternative implementations, the initial estimate assigns a most likely user location, e.g., of a user device or a group of user devices, a probability of one and the remaining user locations are assigned the probability of zero. The most likely user location can be previously determined or determined using a different estimation scheme.

In some implementations, for each IP address block b, the interest locations of all event queries are identified and counted. The interest locations can be weighted by their respective query counts and used to obtain an average location. The average location is used as the estimated user location (loc) for that particular IP address block. Different IP address blocks can have a same average location.

Once each IP address block is associated with an estimated user location, the event queries associated with the same estimated user location, or within a threshold distance of the estimated user location, are collected into a respective set of event queries. Within each set of event queries, there are event queries associated with different IP address blocks. These event queries are also associated with different interest locations. Thus, there are M such different sets of event queries {Q}ₘ, each set associated with a respective user location locₘ.

From each set of event queries {Q}ₘ, the number of event queries for each interest location (ev) is counted. Based on these counts, the probability for each interest location evₙ for the user location locₘ is proportional to that count divided by the total count of event queries in the set {Q}ₘ.

The system obtains (110) an estimate for a probability model p(ev|loc). The probability model p(ev|loc). is an N×M matrix where N is the number of locations of interest, referred to as an interest location, that may be found in a collection of observed event queries, e.g., event queries may directly reference respective interest locations. In particular, the probability p(ev|loc) matrix can be derived from the initial user location estimates for the IP address blocks from the observed N(ev|b).

The values of a particular p(evᵢ|locⱼ) represents the probability that event queries issued from locⱼ would have an interest location ev₁. For example, if a first interest location is Singapore, ev₁=Singapore, and a first location is Italy, locⱼ=Italy, then a probability of p(ev₁|loc₁)=0.03 would indicate that out of the event queries issued from user locations in Italy, 3% contained an interest location of Singapore. The probability model p(ev|loc) represents the probability for all IP address blocks and not for any specific IP address blocks.

In some implementations, the set of potential locations is a constant although the actual observed locations, e.g., locations identified by event queries, may only be a small subset of the potential locations. Additionally, the actual observed locations may vary with time. Therefore, the matrix can be constructed such that only non-zero entities are included.

In some implementations, the probability model p(ev|loc) is estimated based on a filtered group of IP address blocks. The IP address blocks can be filtered, for example, based on an initial classifier that identifies IP address blocks that are localized around a particular location according to particular criteria. In some implementations, the filtering seeks to exclude IP address blocks where interest locations do not cluster around a unique center. Thus, the criteria can be, for example:

1. Use the IP address block if 80% of the interest locations are within a radius of 50 km around a location.

2. Use the IP address block if there is a location that appears that appears in 50% of all queries, and 60% of the remaining interest locations are within 100 km around this location.

3. Do not use the IP address block if there are two locations that are more than 50 km apart and each appears in more than 30% of the queries.

Additionally, IP address blocks may be further filtered based on their having a threshold number of associated queries.

Using the estimate for the probability model p(ev|loc), an N×M matrix, and the observed event counts N(ev|b), the system can calculate (115) an estimate for each of the respective probability distributions X(loc) each probability distribution X(loc) being associated with a respective IP address block. Each probability distribution X(loc) includes values X(locₘ) representing a respective probability that users associated with the respective IP address block are located at a user location locₘ. Different techniques can be used to calculate estimates for each of the respective probability distributions X(loc). The Expectation Maximization (EM) process is described below.

Calculating the estimates for a particular probability distribution x(loc) associated with a corresponding IP address block, e.g., IP address block “A,” can be performed using an iterative process of calculating (120) an updated estimate for a probability model q(loc|ev) for the particular IP address block and then using that probability model to calculate (125) an updated estimate for the probability distribution x(loc) for the IP address block. The probability model q(loc|ev) indicates the probability that a user device is located in a geographical location (loc) given that an event query is observed.

The estimate for the probability model and the probability distribution are calculated using an iterative process. The EM process iterates between the E and M steps until the value for X(loc) converges according to a predetermined threshold requirement:

$$( E \text{-} step ) \text{:} q ( loc / ev ) = \frac{p ( ev / loc ) \cdot x ( loc )}{{\sum }_{{loc}^{′}} p ( ev / {loc}^{′} ) \cdot x ( {loc}^{′} )} ,$$

where x(loc) is a current estimate of the probability distribution for user locations for a given IP address block.

For example, for loc₁=Italy, and ev₁=Singapore, q(loc₁|ev₁)=0.3 represents a probability that out of queries having the interest location Singapore and coming from IP address block IPA, 30% come from users located in Italy.

(M-step): Once the system estimates q(loc|ev) for a given IP address block, the system obtains a new estimate for x(loc) based on the following relation,

$$x ( loc ) ∝ {\sum }_{i = 1}^{N} q ( loc / {ev}_{i} ) ,$$

where ev₁, ev₂, . . . ev_{N} are the observed interest locations for the given IP address block.

Iterations between the E and M steps can be performed until the system determines (130) that an exit criterion has been fulfilled. This can include determining if the change in a last step is lower than a predetermined threshold, or that the change in a last number of steps was lower than a predetermined threshold. Other exit criteria can include a maximum number of iterations.

If it is determined that the exit criterion has not been fulfilled (“no” branch from 130), the E and M steps (120) and (125) are repeated.

This iteration can be continued until an exit criterion is fulfilled (“yes” branch from 130). This can include determining if the change in a last step is lower than a specified threshold value, or that the change in a last number of steps was lower than a specified threshold value. Other exit criteria can include a maximum number of iterations performed.

The then-current probability distribution can be used as an estimate for the probability distribution X(loc) of the geographical locations of the device or the group of devices (135). These probability distributions can be used to estimate geographic locations for particular devices.

The system optionally generates (140) a modified estimate of the probability model p(ev|loc). For example, the system can modify the probabilities for one or more (evᵢ|locⱼ) pairs. The probability model can be modified, for example, as part of identifying outliers. Modifying the estimate of the probability model p(ev|loc) is described in greater detail with respect to FIG. 2.

FIG. 2 is a flowchart of an example method 200 of adjusting a probability distribution based on outliers. For convenience, the method 200 will be described with respect to a system having one or more computers that performs the method 200.

Errors in the probability model p(ev|loc) result in errors in the probability distribution X(loc). These errors can be identified by the outliers in the probability distribution X(loc). Thus, identifying outliers in X(loc) provides a way to detect errors in the probability model. In particular, the number of outliers in X(loc) indicates how much error there is in the estimated X(loc) for a particular IP address block. For example, if X(loc) for an IP address block shows probability mass of 0.95 for loc=Italy, and 0.05 for loc=Singapore, it is likely that the probability mass given to loc=Singapore represents outliers, and it probably should belong to loc=Italy as well.

Some of the errors can be introduced by the estimate of a probability model p(ev|loc) generated, for example, as described above with respect to FIG. 1. Therefore, a change to the estimated p(ev|loc) can affect the computation of X(loc) for one or more IP address blocks.

The system obtains (205) an estimate of the probability model p(ev|loc). The probability model can be the initial probability model described above. The system computes (210) probability distribution X(loc) vectors for various IP address blocks using the obtained estimate of the probability model.

The system adjusts (215) the probability for an (evᵢ−locⱼ) value pair. The probability can be adjusted in one direction first, e.g., by increasing the probability by a small amount. The probabilities of other (evᵢ−locⱼ) value pairs are appropriately adjusted to keep the total probability at 1.0. For example, p(evᵢ−locⱼ) can be p(Singapore|Italy) having a probability of 0.03. This probability can be increased by 0.01. The system computes (220) probability distribution X(loc) vectors for various IP address blocks using the adjusted probability model.

The system compares (225) the overall number of outliers determined for X(loc) with and without the adjustment applied to the estimated probability model p(ev|loc). Determining a number of outliers in a probability distribution will be described in detail below with respect to FIG. 3.

If the overall number of outliers increases for many IP addresses, the probability of the adjusted p(evᵢ−locⱼ), e.g. p(Singapore|Italy), was too large and the value for p(evᵢ−locⱼ) is reduced. If the overall number of outliers for X(loc) decreases for many IP addresses, then, the value for p(evᵢ−locⱼ) is increased further until the number of outliers increase again.

The process can be repeated for changes to multiple (evᵢ−locⱼ) value pairs. The changes made to each probability value in p(ev|loc) can be optimized such that overall, the number of outliers for X(loc) for all IP address blocks are reduced. Using the adjusted probability model p(ev|loc), the system can generate an adjusted probability distribution X(loc) using the EM process as described with respect to FIG. 1.

FIG. 3 is a flowchart of an example method 300 for determining outliers in a probability distribution for a particular IP address block. For convenience, the method 300 will be described with respect to a system having one or more computers that performs the method 300.

The system determines (305) a respective radius for each user location in a probability distribution X(loc) for the IP address block. Specifically, for each user location locⱼ in the X(loc) vector, the system calculates a radius r such that a specified probability mass t, for example t=0.10, of X(loc) falls within the r from the user location.

If the probability mass for a user location is less than t, one or more other user locations can be included within a radius rᵢ for each user location locⱼ. Generally, the r for a user location that has many close neighboring user locations will be smaller than the r for a user location that is an isolated user location.

The system calculates (310) a median radius value from the respective radii for all the user locations represented in the probability distribution X(loc).

The system identifies (315) one or more user locations from the probability distribution as outliers where the radii for the identified user locations are at least a first multiplier greater than the calculated median. For example, user locations whose r values are greater than the calculated median value by 5 times can be considered outliers.

The system excludes (320) the identified one or more user locations from the probability distribution as outliers. The process can be repeated after the outliers identified in each cycle are removed from the probability distribution X(loc). Thus, radii can be determined for each remaining user location, a median calculated for these radii, and outliers determined for each cycle of the process. The number of repetitions can be specified, e.g., 3. The process can also be stopped if the removal of the outliers would cause the probability mass remaining of X(loc) to drop below 90% of its original value. In some other implementations, the process is stopped when no more outliers are identified from the determined radii.

In some other implementations, outliers are identified based on error reports. For example, if it is known that a particular IP address block is associated only with locations in Italy, then the other locations that have non-zero probability mass in the vector X(loc) are outliers and can be excluded.

An event query received from a user device can include, for example, a textual search query, a dictionary query, a map query, a rout query, an image query, an audio query, or a video query. In some implementations, other events can be used instead of or in addition to query events when location information can be directly or indirectly identified. Events are generally generated by a user device in response to a user action on the device; however, events may also be generated by the device itself. Events can be interactions of the user or the device with other devices or with resources or services on the network. Events can also be states or changes of state of the device itself that are transmitted to other devices on the network.

Events are described in this specification as being observed, collected, received, or obtained by the system, by which is meant that data representing each of the events is observed, collected, received, or obtained by the system, and that the data includes content of the event. Of particular interest are events that include implicit or explicit information related to the geographical location of the device from which the events originated.

Example systems and methods to obtain and store events from user devices are described in U.S. patent application Ser. No. 13/458,895, the contents of which are hereby incorporated by reference in their entirety.

An event can include viewport data, map coordinates, route information or any user selection of items shown on maps. An event can also include information derived from a user's selection from among search results received in response to a search query. An event can also include a URL or a sequence of URLs visited by a device. Moreover, an event can include web browser cookies or data received from a device, e.g., language settings, time zone settings or region settings. In addition, an event can include postings in a social network or a change of settings in a social network.

For situations in which the systems obtains personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographical location may be generalized where location information is obtained, such as to a city, ZIP code, or state level, so that a particular location of a user cannot be determined. Thus, the user may have control over how information is collected about him or her and used by the system.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining an estimated user location associated with each respective IP address block of a plurality of IP address blocks based on observed events from the IP address block;
obtaining an estimate of a probability model p(ev|loc) using the obtained estimated user locations, the probability model p(ev|loc) including a respective probability distribution of interest locations for each of a plurality of user locations, each value p(evᵢ|locⱼ) of the probability model p(ev|loc) representing a respective probability that event queries issued from a user location locⱼ have an interest location evᵢ;
using the estimate for the probability model p(ev|loc) and the observed events to calculate an estimate for a plurality of probability distributions X(loc), each probability distribution X(loc) being associated with a respective IP address block;
generating a modified estimate of the probability model p(ev|loc) by changing at least some probability values in the probability model p(ev|loc);
calculating a updated estimate for each of the plurality of probability distributions X(loc) using the adjusted estimate of the probability model p(ev|loc);
determining a further adjustment to the estimate of the probability model p(ev|loc) based on a comparison between an overall number of outliers present in the estimates for the plurality of probability distributions X(loc) and an overall number of outliers present in the updated estimates for the plurality of probability distributions X(loc); and
using the estimate of the probability model p(ev|loc) modified with the further adjustment to calculate a further estimate for each of the plurality of probability distributions X(loc).

2. The method of claim 1, further comprising:
for a first probability distribution X₁(loc) in the plurality of probability distributions X(loc)s:
determining respective number of outliers present in the estimate for the first probability distribution X₁(loc); and
determining respective number of outliers present in the updated estimate for the first probability distribution X₁(loc).

3. The method of claim 2, wherein determining the respective number of outliers present in the estimate for the first probability distribution X₁(loc) comprises:
determining a respective radius rₘ for each user location locₘ in the first probability distribution X₁(loc) such that a fraction of the probability mass of the probability distribution X₁(loc) is included in an area centered around the user location locₘ and having the radius rₘ;
calculating a median of the respective radii for all the user locations represented in the first probability distribution X₁(loc);
identifying one or more user locations from the first probability distribution X₁(loc) as outliers for the first probability distribution X₁(loc), where the respective radii for the identified one or more user locations are at least a first multiplier greater than the median; and
excluding the identified one or more user locations from the first probability distribution X₁(loc) as outliers.

4. The method of claim 3, wherein determining the respective number of outliers present in the estimate of first probability distribution X₁(loc) further comprises:
repeating the determining, calculating, identifying, and excluding of claim 3 for a predetermined number of times or until a predetermined threshold amount of the original probability mass is excluded from the first probability distribution X₁(loc).

5. The method of claim 4, wherein the fraction is 10%, the first multiplier is four, the predetermined number of times is 3 times, and the predetermined threshold amount of the original probability mass is 10%.

6. The method of claim 1, wherein using the estimate for the probability model p(ev|loc) and the observed events to calculate an estimate for a plurality of probability distributions X(loc) comprises:
calculating the estimate for the probability distribution X(loc) using an iterative Expectation Maximization (EM) process until a current estimate of the probability distribution X(loc) converges according to a second predetermined threshold, the EM process comprising:
computing a probability model q(loc|ev) based on the current estimate of the probability distribution X(loc) according to a first equation
$$q ( loc / ev ) = \frac{p ( ev / loc ) \cdot X ( loc )}{{\sum }_{{loc}^{′}} p ( ev / {loc}^{′} ) \cdot X ( {loc}^{′} )} ;$$
and
updating the current estimate of the probability distribution X(loc) according to a second equation
$$x ( loc ) = \frac{1}{N} {\sum }_{i = 1}^{N} q ( loc / {ev}_{i} ) ,$$
where ev₁, ev₂, . . . ev_{N}, represents observed interest locations.

7. The method of claim 1, wherein:
adjusting the estimate of the probability model p(ev|loc) further comprises increasing a first value p(ev₁|loc₁) of the probability model p(ev|loc) by a first amount; and
determining the further adjustment to the estimate of the probability model p(ev|loc) based on the comparison comprises:
upon determination that the overall number of outliers present in the updated estimates for the plurality of probability distributions X(loc) is greater than the overall number of outliers present in the estimates for the plurality of probability distributions X(loc), reducing the first amount added to the first value p(ev₁|loc₁) or decreasing the first value p(ev₁|loc₁) of the probability model p(ev|loc) by a second amount.

8. A system comprising:
one or more computers configured to perform operations comprising:
obtaining an estimated user location associated with each respective IP address block of a plurality of IP address blocks based on observed events from the IP address block;
obtaining an estimate of a probability model p(ev|loc) using the obtained estimated user locations, the probability model p(ev|loc) including a respective probability distribution of interest locations for each of a plurality of user locations, each value p(evᵢ|locⱼ) of the probability model p(ev|loc) representing a respective probability that event queries issued from a user location locⱼ have an interest location evᵢ;
using the estimate for the probability model p(ev|loc) and the observed events to calculate an estimate for a plurality of probability distributions X(loc), each probability distribution X(loc) being associated with a respective IP address block;
generating a modified estimate of the probability model p(ev|loc) by changing at least some probability values in the probability model p(ev|loc);
calculating a updated estimate for each of the plurality of probability distributions X(loc) using the adjusted estimate of the probability model p(ev|loc);
determining a further adjustment to the estimate of the probability model p(ev|loc) based on a comparison between an overall number of outliers present in the estimates for the plurality of probability distributions X(loc) and an overall number of outliers present in the updated estimates for the plurality of probability distributions X(loc); and
using the estimate of the probability model p(ev|loc) modified with the further adjustment to calculate a further estimate for each of the plurality of probability distributions X(loc).

9. The system of claim 8, further configured to perform operations comprising:
for a first probability distribution X₁(loc) in the plurality of probability distributions X(loc)s:
determining respective number of outliers present in the estimate for the first probability distribution X₁(loc); and
determining respective number of outliers present in the updated estimate for the first probability distribution X₁(loc).

10. The system of claim 9, wherein determining the respective number of outliers present in the estimate for the first probability distribution X₁(loc) comprises:
determining a respective radius rₘ for each user location locₘ in the first probability distribution X₁(loc) such that a fraction of the probability mass of the probability distribution X₁(loc) is included in an area centered around the user location locₘ and having the radius rₘ;
calculating a median of the respective radii for all the user locations represented in the first probability distribution X₁(loc);
identifying one or more user locations from the first probability distribution X₁(loc) as outliers for the first probability distribution X₁(loc), where the respective radii for the identified one or more user locations are at least a first multiplier greater than the median; and
excluding the identified one or more user locations from the first probability distribution X₁(loc) as outliers.

11. The system of claim 10, wherein determining the respective number of outliers present in the estimate of first probability distribution X₁(loc) further comprises:
repeating the determining, calculating, identifying, and excluding of claim 3 for a predetermined number of times or until a predetermined threshold amount of the original probability mass is excluded from the first probability distribution X₁(loc).

12. The system of claim 11, wherein the fraction is 10%, the first multiplier is four, the predetermined number of times is 3 times, and the predetermined threshold amount of the original probability mass is 10%.

13. The system of claim 8, wherein using the estimate for the probability model p(ev|loc) and the observed events to calculate an estimate for a plurality of probability distributions X(loc) comprises:
calculating the estimate for the probability distribution X(loc) using an iterative Expectation Maximization (EM) process until a current estimate of the probability distribution X(loc) converges according to a second predetermined threshold, the EM process comprising:
computing a probability model q(loc|ev) based on the current estimate of the probability distribution X(loc) according to a first equation
$$q ( loc / ev ) = \frac{p ( ev / loc ) \cdot X ( loc )}{{\sum }_{{loc}^{′}} p ( ev / {loc}^{′} ) \cdot X ( {loc}^{′} )} ;$$
and
updating the current estimate of the probability distribution X(loc) according to a second equation
$$x ( loc ) = \frac{1}{N} {\sum }_{i = 1}^{N} q ( loc / {ev}_{i} ) ,$$
where ev₁, ev₂, . . . ev_{N}, represents observed interest locations.

14. The system of claim 8, wherein:
adjusting the estimate of the probability model p(ev|loc) further comprises increasing a first value p(ev₁|loc₁) of the probability model p(ev|loc) by a first amount; and
determining the further adjustment to the estimate of the probability model p(ev|loc) based on the comparison comprises:
upon determination that the overall number of outliers present in the updated estimates for the plurality of probability distributions X(loc) is greater than the overall number of outliers present in the estimates for the plurality of probability distributions X(loc), reducing the first amount added to the first value p(ev₁|loc₁) or decreasing the first value p(ev₁|loc₁) of the probability model p(ev|loc) by a second amount.

15. A computer storage medium encoded with a computer program, the program comprising instructions that when executed by one or more computers cause the one or more computers to perform operations comprising:
obtaining an estimated user location associated with each respective IP address block of a plurality of IP address blocks based on observed events from the IP address block;
obtaining an estimate of a probability model p(ev|loc) using the obtained estimated user locations, the probability model p(ev|loc) including a respective probability distribution of interest locations for each of a plurality of user locations, each value p(evᵢ|locⱼ) of the probability model p(ev|loc) representing a respective probability that event queries issued from a user location locⱼ have an interest location evᵢ;
using the estimate for the probability model p(ev|loc) and the observed events to calculate an estimate for a plurality of probability distributions X(loc), each probability distribution X(loc) being associated with a respective IP address block;
generating a modified estimate of the probability model p(ev|loc) by changing at least some probability values in the probability model p(ev|loc);
calculating a updated estimate for each of the plurality of probability distributions X(loc) using the adjusted estimate of the probability model p(ev|loc);
determining a further adjustment to the estimate of the probability model p(ev|loc) based on a comparison between an overall number of outliers present in the estimates for the plurality of probability distributions X(loc) and an overall number of outliers present in the updated estimates for the plurality of probability distributions X(loc); and
using the estimate of the probability model p(ev|loc) modified with the further adjustment to calculate a further estimate for each of the plurality of probability distributions X(loc).
